(19) United States
(12) Patent Application Publication
(10) Pub. No.: US 2023/0206319 A1
(43) Pub. Date: Jun. 29, 2023

(54) METHOD AND APPARATUS FOR CREATING ALTERNATIVE DATA RISK ASSESSMENT USING MOBILE DATA

(71) Applicant: CrePASS Solutions Inc., Seoul (KR)

(72) Inventor: Min Jung KIM, Seoul (KR)

(73) Assignee: CrePASS Solutions Inc., Seoul (KR)

(21) Appl. No.: 17/563,676

(22) Filed: Dec. 28, 2021

(51) Int. Cl. G06Q 40/02

(52) U.S. Cl. CPC G06Q 40/025

(57) ABSTRACT

A method for creating an alternative data risk assessment using mobile data includes collecting mobile risk data from a mobile terminal, constructing a mobile data risk model for a risk assessment by analyzing the mobile risk data, assessing a risk of a specific user using the mobile risk data and the mobile data risk model, and executing a loan for the specific user according to a result of the assessment.

### BACKGROUND

The present disclosure relates risk assessment technology, and more particularly, to a method and apparatus for creating alternative data risk assessment using mobile data to allow users to use a loan financially or non-financially using personal data provided by individual users and data collected from individuals' online traces.

Fair Isaac & Co. (FICO) Credit has developed a credit scoring method for rating credit as a reliable means and helping lenders determine the likelihood of a credit user (i.e., a borrower)'s paying off a debt.

A borrower is a party who seeks or secures a temporary use of monetary funds or non-monetary objects, subject to the return of an equal or equivalent amount and for an interest fee in many cases. A loan agent is a party that temporarily uses or permits a monetary fund or non-monetary object on the condition that an equal or equivalent amount will be returned, and charges an interest fee in many cases. In this case, the loan agent may be a private organization, an individual, or a government agency.

An FICO score is created from a credit scoring method of condensing a borrower's credit history into a single number. Credit scores are calculated using a credit model and a mathematical table that aggregates a variety of information allowing rough estimation of a borrower's future credit performance. Developers of scoring models want to find predictors that may indicate future credit performance from data. For example, predictors such as the amount of credit already used versus the amount of credit that is available, the period of employment at a current job, negative credit information such as bankruptcy, etc. may be revealed through the a borrower's credit history.

There are three representative FICO scores that are calculated from data provided by each of the most prevalent credit rating companies, and the credit rating companies provide FICO scores so that lenders may determine a credit value. However, there is a problem in that it is difficult to determine credit scores of borrowers because many customers do not have a loan history. For this reason, traditional lending models cannot provide adequate capital to those in need. As a result, microfinance has evolved to be accessible to individuals and small organizations in the market with little or no credit (the terms ‘microloan’, ‘lending, ‘loan application process’ and ‘credit application process’ as used herein may generally be used interchangeably).

Microfinance through peer-to-peer (P2P) may be a quick and easy way to use small loans. This may include loans, typically less than $5 million, to individuals or small organizations that lack collateral or do not have the ability to prove that they may repay the loan to an existing bank. Traditional financial institutions are reluctant to develop services that provide microfinance due to costs for processing small loans and the risks associated with lending to individuals and small organizations. Microfinance beneficiaries are considered risky customers because they have a limited financial record. For this reason, microfinance generally inevitably relies on unconventional aspects of collateral requirements and unconventional assessments of credit values.

### RELATED ART DOCUMENT

### Patent document

Korean Laid-open Publication No. 10-2006-0002321 (published on Jan. 9, 2006)

### SUMMARY

In view of the above, the present disclosure provides a method and apparatus for creating an alternative data risk assessment using mobile data to allow users to use a loan financially or non-financially using personal data provided by individual users and data collected from individuals' online traces.

The present disclosure also provides a method and apparatus for creating an alternative data risk assessment using mobile data, capable of verifying an identity of an individual in an implementation process, determining an individual's credit value for the purpose of a loan, and performing repayment measures on individual borrowing transactions through collection measures using non-financial transactions (e.g., equipment rental, information sharing, leasing, bartering, replacement etc.) and a personal social network trace.

In embodiments, a method for creating an alternative data risk assessment using mobile data includes: collecting mobile risk data from a mobile terminal; constructing a mobile data risk model for a risk assessment by analyzing the mobile risk data; assessing a risk of a specific user using the mobile risk data and the mobile data risk model; and executing a loan for the specific user according to a result of the assessment.

The collecting may include receiving risk data at a specific time from the mobile terminal through a mobile-based software development kit (SDK), and the SDK may obtain an authority to access data for the mobile terminal in the process of transmitting the risk data.

The collecting may include collecting, as the mobile risk data, data collected from a user's social graph and an online social trace from the mobile terminal.

The assessing of the risk may include: determining a risk variable from the mobile risk data; and creating the mobile data risk model using the risk variable as a model variable.

The executing of the loan may include determining at least one of a loan interest rate and a loan period for executing the loan according to the result of the assessment.

The method may further include: adding the specific user to a group of loan holders when the execution of the loan is completed; and performing a periodic risk assessment on the group of loan holders to determine a loan management procedure for the corresponding loan holders.

The determining of the loan management procedure may include changing a notification schedule of the corresponding loan holder or changing a collection procedure in case of overdue according to the result of the risk assessment.

In embodiments, an apparatus for creating an alternative data risk assessment using mobile data includes: data collecting unit configured to collect mobile risk data from a mobile terminal; a risk model constructing unit configured to construct a mobile data risk model for a risk assessment by analyzing the mobile risk data; a risk assessing unit configured to access a risk of a specific user using the mobile risk data and the mobile data risk model; and a load executing unit configured to execute a loan for the specific user according to a result of the assessment.

The disclosed technology may have the following effects. However, this does not mean that a specific embodiment should include all of the following effects or only the following effects, so the scope of the disclosed technology should not be construed as being limited thereby.

In the method and apparatus for creating an alternative data risk assessment using mobile data according to an embodiment of the present disclosure, users may be allowed to use a loan financially or non-financially using personal data provided by individual users and data collected from individuals' online traces.

In the method and apparatus for creating an alternative data risk assessment using mobile data according to an embodiment of the present disclosure, an identity of an individual may be verified in an implementation process, an individual's credit value for the purpose of a loan may be determined, and repayment measures may be performed on individual borrowing transactions through collection measures using non-financial transactions (e.g., equipment rental, information sharing, leasing, bartering, replacement etc.) and a personal social network trace.

### BRIEF DESCRIPTION OF THE DRAWINGS

FIG. 1 is a view illustrating apparatus for creating alternative data risk assessment according to the present disclosure.

FIG. 2 is a flowchart illustrating an embodiment of a loan execution process according to the present disclosure.

FIG. 3 is a flowchart illustrating a method of creating a user dashboard and managing the user dashboard according to the present disclosure.

FIGS. 4 and 5 are views illustrating a web page showing a type of profile information requested according to the present disclosure.

FIG. 6 is a view illustrating a web page for displaying a notification to a user that the user has not yet been proven to be credible according to the present disclosure;

FIG. 7 is a view illustrating a web page for a loan application according to the present disclosure.

FIG. 8 is a flowchart illustrating a method of collecting information from a user as part of a loan application according to an embodiment of the present disclosure.

FIG. 9 is a view illustrating an embodiment of a process of determining a credit value for a user.

FIG. 10 is a flowchart illustrating an embodiment of a loan transaction according to the present disclosure.

FIGS. 11A and 11B are views illustrating the most important position variables and each prediction information value IV according to the present disclosure.

FIG. 12 is a view illustrating a process of calculating a default rate according to the present disclosure.

FIG. 13 is a view illustrating a cumulative approval rate according to the present disclosure.

### DETAILED DESCRIPTION

The description of the present disclosure is merely an embodiment for structural or functional descriptions, and thus, the scope of the present disclosure should not be construed as being limited by the embodiment described in the text. That is, since the embodiment may be variously modified and may have various forms, it should be understood that the scope of the present disclosure includes equivalents for realizing the technical idea. In addition, since the object or effect presented in the present disclosure does not mean that a specific embodiment should include all of them or only such effects, it should not be understood that the scope of the present disclosure is limited thereby.

The present disclosure relates to an apparatus, computer media and method for analyzing data collected from online social network traces and determining a credit score to facilitate access to financial services, in which a credit score may be determined based on available personal data and data collected from online social network traces and may be used as an indicator of borrowers' propensity to repay a loan amount.

Here, the credit score may be determined as an expression score associated with a group (grouped by score) that generally includes a portion of the available data collected from online social network traces. In addition, credit scores may be affected by means such as positive or negative behaviors of individuals in a borrower's social network.

Accordingly, the present disclosure may provide an apparatus, system, computer program and communications mechanism for providing financial services based on at least one or more of borrower's request criteria, optimized reputation in the borrower's online social network trace, and loan transaction performance.

Reference will be made in detail to embodiments of the present disclosure, examples of which are shown in the accompanying drawings. In addition, numerous specific details are set forth in the detailed description below in order to provide a thorough understanding of the present disclosure. The description below is intended for online loan and credit systems for users of wireless electronic mobile devices (e.g., smartphones, etc.), which describes the different aspects of the various technologies of combining social networking and lending to allow individuals to obtain or provide simple and secure loans in a timely and cost-effective manner.

It is self-evident that the present disclosure may be implemented without these specific details, and detailed descriptions of well-known methods, procedures, components, circuits, and networks are limited not to unnecessarily obscure aspects of the embodiments. Accordingly, the present disclosure is not limited to any particular embodiment, aspect, concept, structure, function, or illustration described herein, but may be used with advantages in computing, communication, data sharing generally in highly dynamic environments and various methods providing such advantages.

As used herein, the terms “user”, “borrower”, “individual”, “client”, “participant”, “device” and “member” may generally be used interchangeably.

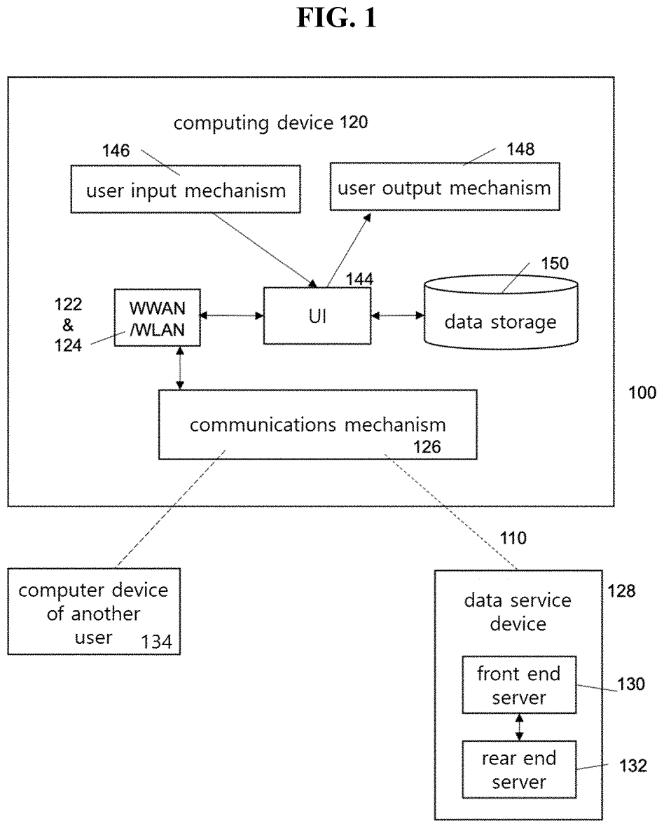

FIG. 1 is a view illustrating an apparatus for creating an alternative data risk assessment according to the present disclosure. That is, FIG. 1 illustrates an embodiment of a computing device executing software instructions, a user interface for such device, and a related process for using such device.

A user interface 144 may enable access to a website through a user interface display method of a system in a user computing device 120 and may be generally implemented as a software program suitable for a computer website or portable electronic device available for the Internet. A user computing device 120 may be tightly connected to other user computing device 134 in a client-server arrangement or similar distributed computer network. One or more embodiments may be implemented in a computer network system 100 as shown in FIG. 1.

A data service device 128 in the computer network system 100 may be directly or indirectly connected to one or more user computing devices 120 via a network 110. A network interface between the data service device 128 and the user computing device 120 may include one or more routers that provide services. The router may buffer and route data transmitted between the server and the user computing device 120. The network may correspond to the Internet, a wide area network (WAN), a local area network (LAN), or a combination thereof.

In an embodiment, the data service device 128 may be a WWW (World-Wide Web) server storing data in the form of web pages and transmitting the page as a hypertext markup language (HTML) file to the user computing device 120 over a network (i.e., the Internet). The user computing device 120 may typically execute a web browser program to access web pages provided by data service device 128 and any available content providers or supplemental servers.

Meanwhile, the network connection shown in FIG. 1 is an example, and other methods of establishing a communication link between computers may be used. Various well-known protocols such as TCP/IP, frame relay, Ethernet, FTP, HTTP, etc., may be considered to exist and computers may operate within a client-server environment configuration that allows users to retrieve web pages from web-based servers. Additionally, various existing web browsers may be used to display and manipulate data on web pages.

The operation of the user computing device 120 may be controlled by various program components. For example, program components may include routines, programs, entities, components, and data structures that perform particular tasks or implement particular abstract data types.

In an embodiment, the data service device 128 of an online credit application process may correspond to a server executing a server-side online credit application process. In other embodiments, the user computing device 120 may execute the corresponding process. The online credit application process may be stored in the network service device 128 and implemented as one or more executable program modules executed locally within the server. However, alternatively, the online credit application process may be stored in a remote storage device or may be processed in the data service device 128 or a network device and may be locally executed in the data service device 128 so as to be connected. In another embodiment, the computer network system 100 (hereinafter referred to as a ‘system’) for online credit application processing may be implemented as a plurality of different program modules, each of which may be connected to two or more distributed server computers connected to each other or may be executed by a separate network.

In an embodiment in which the network 110 is implemented as the Internet, the data service device 128 may execute a web server process to provide an HTML document, generally in the form of a web page, to the user computing device 120 connected to the network. To access HTML files provided by data service device 128, user computing device 120 may execute a web browser process to access web pages available in the data service device 128 and other Internet servers. The user computing device 120 may access the network through an Internet service provider (ISP). Data for loan products, credit products, debt products, and user information, etc. may be provided by a data storage 150 tightly or loosely coupled with either the data service device 128 and the system 100.

The user computing device 120 may correspond to a workstation computer or a computing device such as a notebook computer, a personal digital assistant, and a wireless electronic mobile communication device (e.g., a smartphone). In addition, the user computing device 120 may be implemented as a similar computing device providing a sufficient level of user input and processing capability to access a mobile communication device, game console, media playback device, or Internet-connected network 110 or execute or access the system 100. The user computing device 120 and other user computing devices 134 may be connected to data service device 128 via a wired connection, a wireless connection, or any combination thereof.

As an example implementation, a participating user may carry a wireless electronic mobile communication device as an interface for a social networking environment as described 0 herein. The corresponding mobile communication device may execute certain mobile phone software and may provide wide/range cellular data services such as GPRS/EDGE, CDMA1x, or 3G. As used herein, such wireless wide area networking may be referred to as ‘WWAN’ 122 as in ‘WWAN connection’ of a mobile communication device. In addition, the corresponding mobile communication device may provide a short-range wireless networking function such as Bluetooth or Wi-Fi. Such short-range networking may be referred to as ‘WLAN’ 124 as in ‘WLAN connection’ of the mobile communication device.

These WWAN 122 and WLAN 124 device functions may each be coupled to a communications mechanism 126 with additional communications software and hardware. The WWAN 122 may be connected to the data service device 128, which may include a user data server including a front end server 130 and a rear end server 132. Also as described above, the WLAN 124 may be coupled to one or more other client devices within the same social network as the user computing device 120, i.e., other user computing device 134.

It should be noted that although the illustrated devices have the wireless networking function mentioned above, not all devices need to have the same function. For example, a mobile device such as a PDA or laptop computer only needs a WLAN connection to other devices in the social network.

A user may interact with an application as illustrated in FIG. 1 by a user interface (i.e., a UI component) 144, a user input mechanism 146, and a user output mechanism 148. For example, each user may share text, photos, graphics, and/or video clips that may be uploaded in the data storage 150 of FIG. 1 with a friend via the user computing device 120. (Since wireless communication is often intermittent in nature, a portion of the data may be cached and stored in an online social networking data server, etc.). Thus, the term ‘file content’ as used herein may refer to certain data including text, images, graphics, audio and/or video. The system 100 may deliver these different data streams from different sources to a loosely coupled group of users in a timely and cost-effective manner.

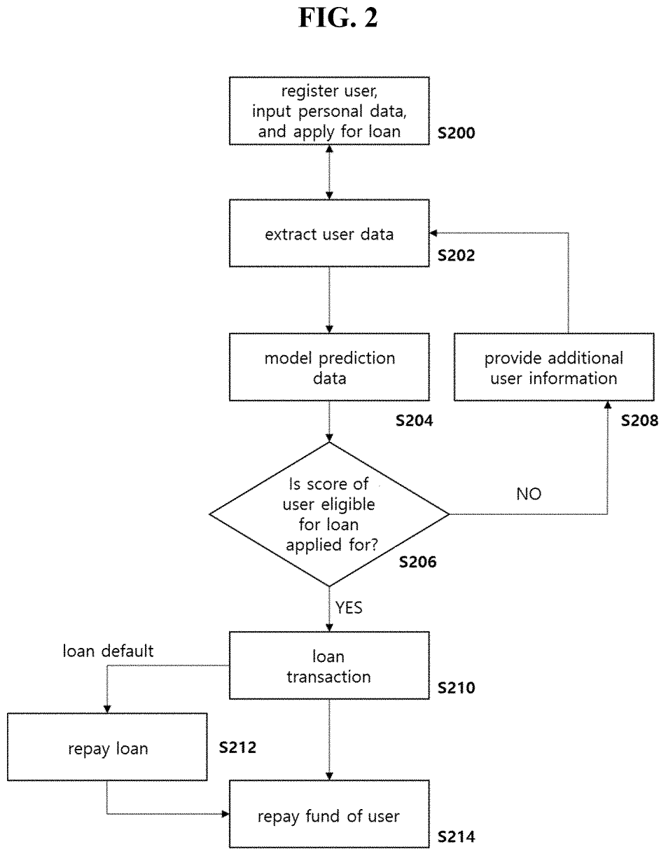

FIG. 2 is a flowchart illustrating an embodiment of a loan execution process according to the present disclosure.

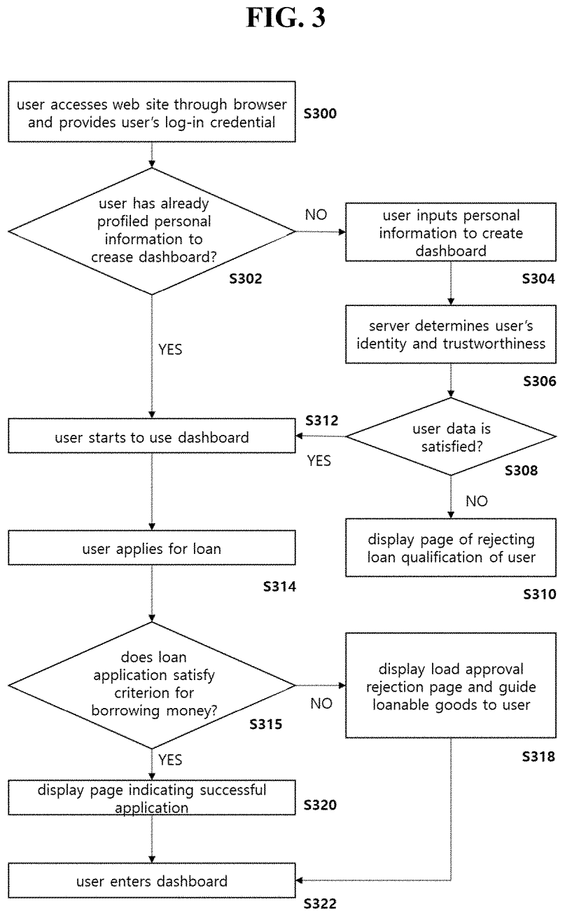

Referring to FIG. 2, the system 100 may execute a loan based on insight-based borrower interactions in a social graph. In FIG. 2, an individual who wants to borrow funds should register to the system 100 and may create a user profile by inputting personal data through a web site or user interface 144 of the system 100. The web site may be accessed through a computer or application program suitable for any means of displaying the user interface 144 of the system 100 (typically a portable electronic device). Now that the individual is registered as a user in the system, the borrower's user profile may be reflected in a user information dashboard. The user may access a loan application through the dashboard, which may be displayed on the user's computer or portable electronic device. In operation S200, contents on additional tools for user and dashboard management functions is illustrated in FIG. 3.

When the user applies for a loan in operation S200, the system 100 may retrieve a social graph through the data service device 128 to extract user data from a user's online social trace (operation S202).

The social graph may be formed based on a user's social relationship. A user's social relationship may be managed by a new user setting up a profile in the system, a user applying for a loan, or a user specifying a social connection through a ‘trusted connection’. A corresponding list may be recorded in the user data server when the user registers to the system. Since the data server already has a social network list for registered users, the server may easily form a new social graph using the registered user's direct friendship or contact information. Through such a social graph, not only a direct friend of the user but also a common user in the social graph may be connected. Being socially connected may provide collaboration between users and lower potential security or privacy concerns for sharing. For example, the user may configure a user-designated membership within a trusted network, such as setting a level of the number of indirect neighbors allowed to include or exclude certain other users. A customized trusted private network created by the user may include social networks made up of lenders, borrowers, loan vehicles, and other affiliates such as friends, family and classmates, colleagues, neighbors, teachers, and acquaintances and may also include complex information sharing networks not limited thereto.

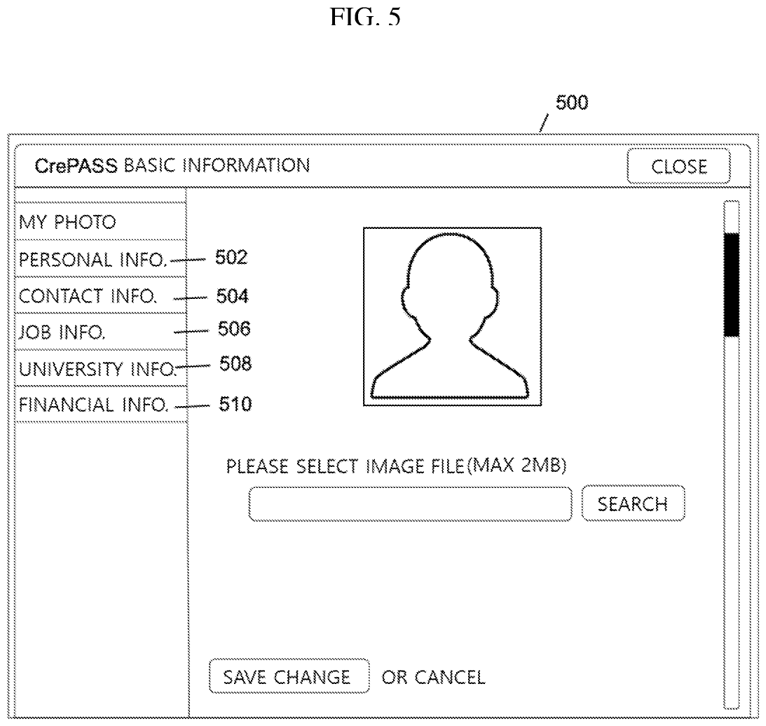

As shown in FIG. 2, a general data flow between user computing device 120 and data server may include the data service device 128 serving as a bridge for communication and storage between different users in the social graph (e.g., the server hosts current and historical data for each user). In operation CREDENTIAL, user data may be integrated with data collected from online social traces and other data as required by specific requirements of a prediction model. A description of a process flow according to an embodiment may be provided in FIG. 5.

The prediction model created in operation S204 may correspond to a credit model providing configuration for a plurality of score clusters or intervals and related score expression, which will be described in more detail below. Information processed and created via the prediction model may be used to determine whether a user's score is suitable for a loan request or not. The corresponding determination may be performed by creating a credit score and may also be utilized to determine a type of repayment processing of the user applying for a loan being processed. A next operation of operation S206 may include fulfilling the loan request by supplying the requested funds to the user or requesting the user to take action to improve his or her score in order to receive the funds. If it is determined in operation S206 that the user is not eligible for the loan, the server may display a page indicating that the user is not eligible for the loan applied for. The user is not eligible for the load when a credit score does not meet a threshold risk acceptable criterion, when the information of the provided data profile and information collected from the user's social space do not match, when log-in credential do not work, or when the user's credit value is weakened because members of the user's social network have high risk factors.

A web page presented to the user may include contents explaining why the loan was not approved. In addition, the server may provide the user with an alternative loan that the system determines is affordable for the user. In operation S208, if it is determined that the user's credit value will improve and the likelihood of becoming eligible for a loan will increase, the server may provide the user with a method of improving the credit score. Measures to increase the credit score may include finishing interactive educational content on financial responsibility, providing more personal data and increasing users' access to social graphs, gaining more endorsements from friends and affiliates in the network, and resolving prominent negative perceptions reducing a credit score. As more data becomes available about the borrower, the prediction model may be updated and the credit model matching process may continue as described above.

If it is determined in operation S206 that the user is eligible for the selected loan product, the server may notify the user that the loan is approved. Thereafter, if the user accepts a loan condition, the loan may be transacted and funds may be delivered to the user (operation S210). Loan approval notifications to the user may be delivered through various methods, including sending an email message, sending a text message, providing a web page notification to the user, or a message or display on the user's dashboard.

The funds may be deposited directly into the user's bank account as specified in the user's profile information included in the user's dashboard using an electronic money transfer system. The user may repay the loan through a variety of digital payment methods, including, but not limited to, direct debit, mobile payment, automated teller machine (ATM) deposit, prepaid card, wire transfer, and bank deposit. If the user fully meets the requirements of the loan agent specified in transaction conditions (operation S214), the loan transaction may be considered to be completed. If the transaction is a financial transaction, it cannot be considered to be completed until repayment of all outstanding amounts (including interest or fees) is met. If the transaction is a non-financial transaction, transaction conditions, such as returning a borrowed entity to its rightful owner on a specific date and on specific conditions should be met.

With respect to an interest rate charged on a loan transaction, any interest fees may vary widely according to lenders. Often, lenders may reflect high operating and financing costs for local lending activities and smaller loans. The present disclosure may provide a system that may lend money at an interest rate less than a legal maximum interest rate. In an embodiment of the present disclosure, the interest rate may vary depending on the borrower's credit score and a local interest rate of a borrower's country, and the period may vary from several weeks to several years.

An embodiment of the present disclosure may support a repayment processing of the loan if the borrower cannot make timely payment for the loan repayment or does not meet the agreed conditions (operation S212). The repayment processing may include posting information on a user's default or delinquency on the loan in various social networks and user networks. Failure of an individual borrower to pay off his/her loan timely may prevent a borrower of another group from making future borrowing. Repayment measures may include any combination that affects the credit value of a referrer, a family member, or a partner in a cooperative relationship. More specifically, online social traces of those associated with the ‘problematic’ borrower who is unable to repay his/her loan or fail to meet relevant terms and conditions may be affected, reflecting negative associations. Thus, a group may effectively provide informal joint guarantees for the user's loan, usually by encouraging delinquent users to pay in a timely manner, either by wanting to pay on behalf of the defaulting user or by coercing their peers in case of willful default. These normative controls may have the effect of encouraging responsible repayment. If a problem arises, the credit score of the user may be lowered for future loan requests. As a result, by ensuring credit discipline through mutual support and peer pressure within the group, individual users may act to conduct their financial matters prudently and expedite loan repayments.

In an embodiment, a user's credit score may be negatively affected by the poor loan repayment performance of the user or someone associated with the user. As the user repays the loan, information on the user's loan performance may be maintained as part of a credit rating process in the user and user network. Thus, as the loan performance is better, the loan approval may be more easily performed on the user and those in the user network. The user may manage changing personal information as well as monitor the loan performance of his/her own and others in the network through news feeds, warnings and messages available on the user's dashboard.

FIG. 3 is a flowchart illustrating a method of creating a user dashboard and managing the user dashboard according to the present disclosure.

Referring to FIG. 3, the user may participate in the system 100 in operation S300. For existing users, the user may enter the system website through a browser and provide the user's log-in credential. In operation S304, when the user uses the system for the first time, the user may input specific personal information items such as name 502, address 504, date of birth, employment history 506, and education level 508 to share his/her profile.

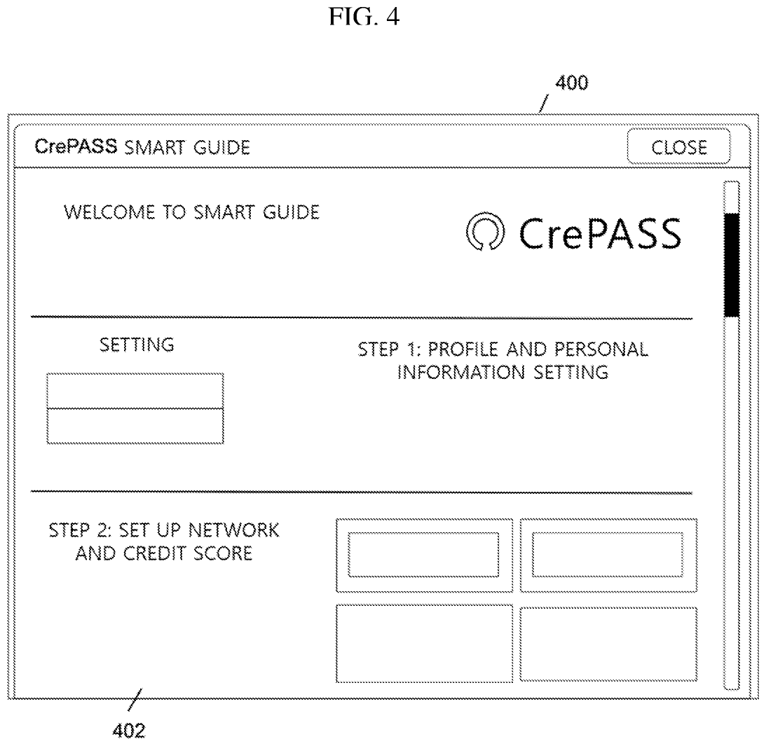

For example, the personal information items may include income level 510, assets, liabilities, demographic information, referees, affiliates, associations, social security numbers, or other uniquely identifiable information items such as passport numbers, driver's license number, etc. Users may also be asked to input information on their job, short-term and long-term goals, monthly income, and outstanding debt amounts. In some cases, users may also be asked to provide proof of the monthly income. A user's profile may require the user to input social network 402 into the social graph in which he/she is participating or a member, and may include Twitter, Facebook, LinkedIn, MSN, Yahoo!, Gmail, Google Plus+, MySpace, and MeetUp. FIGS. 4 and 5 are views illustrating a web page showing a type of profile information requested according to the present disclosure.

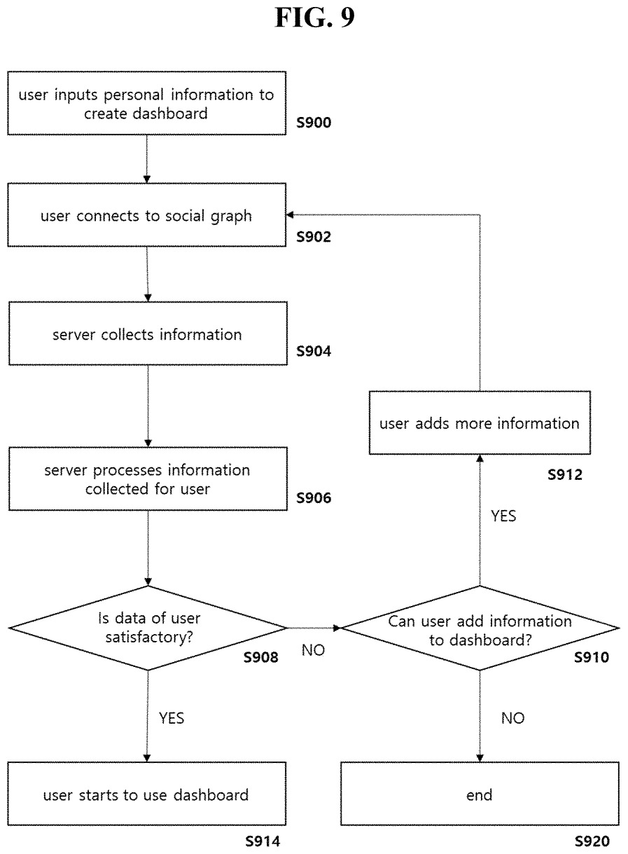

The user provide log-in information to the social network using part of social network representation so that the server may verify the user's identity. Information collected from social networks in which users participate may be used, as a factor determining the user's credit risk level, to access the user's personality and credibility. The corresponding process is illustrated as operation S306 in FIG. 3, and an exemplary process flow of this embodiment is further illustrated in FIG. 9.

In operation S306, the server may receive a user's credit rating report. In general, if the information the system 100 may use to determine a credit risk does not match or presents evidence of a user's trustworthiness or dishonesty, the credit score may be highly likely to be lowered. For example, if a user has indicated in his/her profile that he/she works as an engineer but if a message indicating that he/she is working as a sweeper within the last 48 hours after submitting a loan application, then the data collected about him may not meet the credit score criteria. If the system 100 does not determine that the user has an appropriate level of credit based on the scoring representation of the credit model, that is, the low credit score, the user may not be allowed to apply for a loan (operation S308).

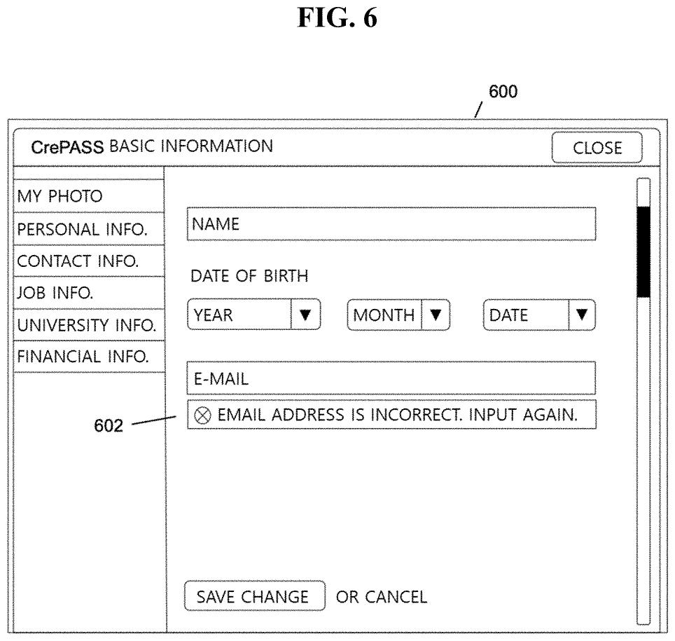

The web page 600 shown in FIG. 6 may correspond to displaying a notification to the user that the user has not yet been proven to be credible. In the case of FIG. 6, basic profile information such as an e-mail account cannot be checked (602). If the system 100 determines that the user has an appropriate level of credit value, that is, a credit score above a minimum threshold level, the user may apply for a loan through the user's dashboard (operations S312 and S314).

When the user accesses his/her dashboard, the user may apply for a loan using a dashboard management tool as indicated in operations S312, S314, S318, S320, and S322.

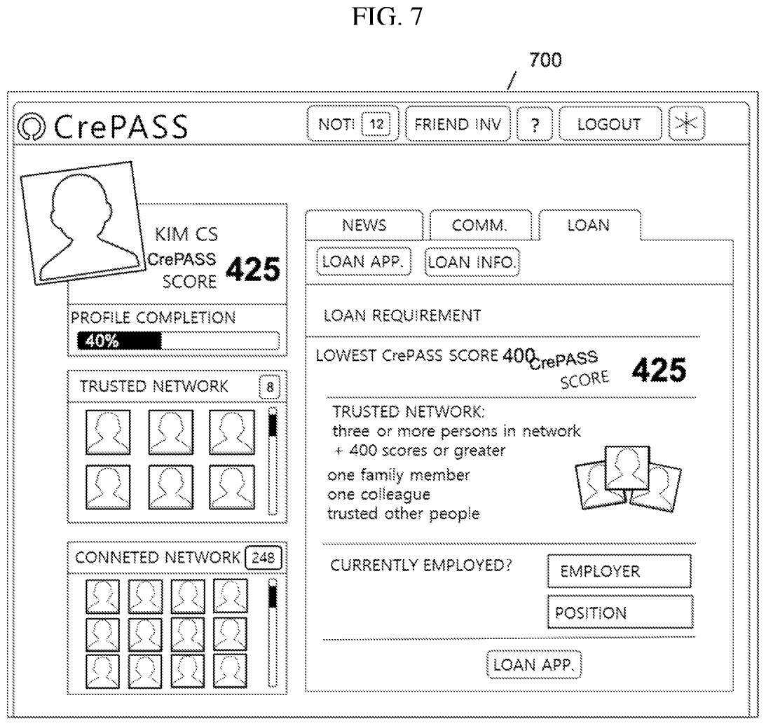

In another embodiment, the system 100 for an online loan application process may be brokered directly through a dashboard interface. FIG. 7 shows an example of a web page 700 for applying for a loan. The web page 700 may display a typical loan application page for the online loan application process and display data input areas for required relevant user information and loan requirement information.

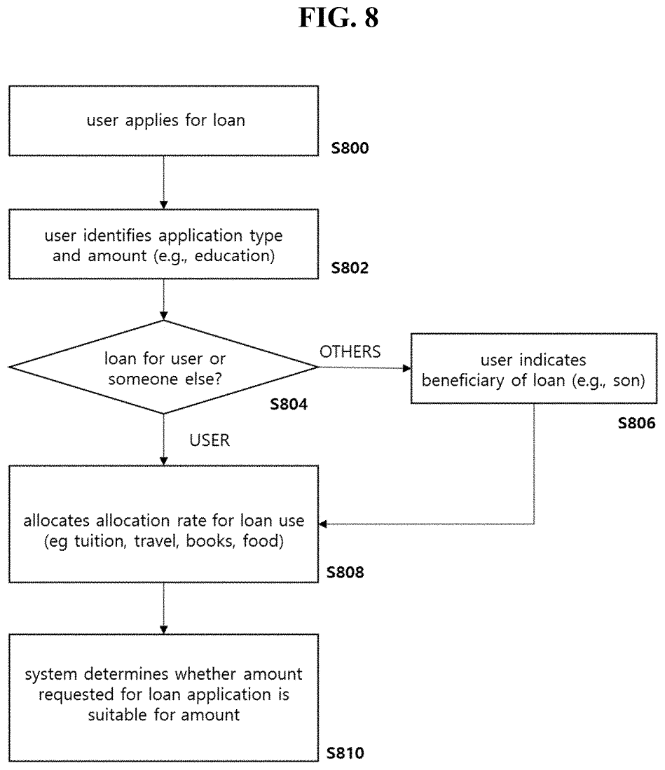

FIG. 8 is a flowchart illustrating a method of collecting information from a user as part of a loan application according to an embodiment of the present disclosure. In FIG. 8, the user may select a loan application (operation S800). In an embodiment, the user may manage the loan application process through the user's dashboard. A loan application form is displayed for the user via a web site displayed on the user's computer, which allows the user to access a system such as a portable electronic device. The loan application form may ask the user for information on loan parameters such as the desired loan type and amount. In operation S802, the user may input loan information indicating the type or purpose and amount of a desired loan. The user may be asked to indicate a beneficiary of the loan being applied for (operation S806). For example, the loan may be for the user himself or for a friend or a child, sibling, parent, or a relative such as cousin. In operation S808, the loan application may request the user to indicate the purpose of the loan as indicated by an allocation percentage. For example, in the case of an education loan, 5% may be spent on travel, 45% on tuition, and 50% on books.

Loan approval may be rejected if the information provided by the user when applying for a loan does not match the information found in the user's social trace. For example, the user may have applied for a loan of 1 million won for textbook purposes for a class he/she is taking, but the system 100 may find that there is no mention of taking the class in personal information or posts in the user's social network traces. Rather, the system 100 may obtain information through recent activity that the user wants to accompany his friends to a three-day music concert that sells tickets worth one million won. If a situation like the example above occurs, the user's credibility and the possibility of loan approval may be questioned, and this may have a negative effect on loan approval.

The online loan application process on the data service device 128 may determine eligibility of the user based on the loan type and user credit score characterization (operation S810). For example, there may be a case in which a loan amount other than the loan amount requested by the user may be determined. Since the user's monthly income is an indicator of the loan standard, if the loan amount is equal to or exceeds the user's monthly income, an amount other than the desired loan amount may be determined. As shown in FIG. 3, the user may be notified when it is determined whether the user is eligible for a loan, not eligible for a loan, or whether a loan has been approved conditionally but a recommended amount is different, through the online loan application process.

In an embodiment, the user may view a loan status on the user's dashboard as well as manage loan and repayment activities therethrough. The user's dashboard may be used as a means to notify the user if someone on the user's social network achieves a negative result on a loan. This may negatively affect the user's credit score depending on a prediction model, and the corresponding process may be part of a collection processing task of someone connected with the user.

An account management function of the dashboard may play an important role as it helps users affect their credit scores by introducing dynamics into the determination of their credit scores. For example, when monthly income amounts change, the user may control those belonging to the user's trusted network, as well as editing personal profile information, through the dashboard. To help understand the importance of a user's profile information and dashboard management tool as an important embodiment, FIG. 9 may show an embodiment of a process of determining a credit value for a user.

Referring to FIG. 9, the user should check log-in information for his/her social network so that the server may verify the user's identity together with displaying the social network for the user profile. The information collected from the social network in which the user participates may be used to assess the user's personality and credibility (operations S902 and S904). Thereafter, the information may be analyzed to determine a credit risk of the user using a credit model of the online credit application process (operation S906). The corresponding process is illustrated as operation S306 in FIG. 3. If the information collected from the social network in which the user participates and the data submitted by the user are satisfactory, i.e., are consistent and verifiable, and pass a risk acceptable criterion of prediction without presenting evidence of hardship or dishonesty, the user may successfully construct his/her dashboard and apply for a loan.

If the credit risk is too high, that is, if the credit score is not on a satisfactory level determined by the prediction model (operation S908), the user may be prompted to add more information to his/her profile (operation S910). The additional information may include personal data such as employment history and education level (operation S912), and may include inviting members of the user network for personal recommendations. In addition, the user may strengthen a community (e.g., social networks) by indicating which of his/her friends and family are most likely to repay their loans.

With respect to prediction models, an embodiment of the present disclosure may support development of a unique analytical model for assessing the user's ability and assigning a score or rank to the user based on data collected from online social traces and other available data. For example, a score created by a credit model may correspond to a result of predicting the likelihood that the user will repay a loan. In addition, the corresponding score may facilitate the process of lending and collecting by lending agents. A credit model may blend financial information with demographic information input by the borrower that reflects the borrower's solvency and credit history. The system 100 may support appropriate security measures surrounding necessary personal data and credit information.

In an embodiment, a credit prediction model may be created to determine a borrower's credit worth based on the extracted data, and the credit prediction model may be created once an initial borrowing application is defined. Here, the credit prediction model is often developed using statistical methods such as logistic regression, but data mining technology such as neural networks and decision trees may also be used. In addition, the credit prediction model may correspond to a mobile data risk model that may be used to analyze mobile risk data to perform risk assessment. A regulatory model may be defined and executed to determine whether borrowers to match with loan agents and specific borrowers in each sector should be treated as tactical repayments. The credit prediction model may be trained using insights obtained from available personal data, social graphs that represent people who are most likely to pay off debt or not, and data collected from online social traces. Training of these analytical models may be performed using software developed by KXEN, Inc., StarSoft or SAS along with tools for performing modeling.

The system 110 may provide a means to train a prediction model and determine credit worth by collecting online host pattern recognition between payers and non-payers based on available personal data and analysis results obtained from the data. Good information for pattern recognition may include word combinations in text indicating deceptive use of loaned funds or conversely corroborating text confirming intended use of funds. Another analysis of people's behavior on loans to determine credit worth may correspond to geospatial data (e.g., location, places of frequent activity, etc.). Individuals who often spend time in locations common with others who repay their loans well may provide insightful geospatial data. Meanwhile, visual evidence through photos or videos may be another example of insightful data demonstrating common behavior of non-reimbursing people. Biometric information, described further below, may correspond to another example.

In other embodiments, data may be extracted from a database and transformed, aggregated, and combined into standardized scene file records for each borrower. Transforming the data may include user-designated transformation to uncover additional data. The data in the file record may be used as an input to an explanatory and prediction model that determines the likelihood of a borrower repaying a debt. The prediction model may also be used to predict the likelihood of fraud or other behavior. In an embodiment, the prediction model may be used to affect the credit score of other individuals in the user's online social network.

Payment behavior may be modeled based on social reputation data and personal information to predict loan repayment. Advance loan repayment performance may also be used for additional predictive power. Using a credit prediction model implemented in the developed dataset, an evidence in the data may be identified using a cluster analysis algorithms to measure social status and reputation to determine a credit value. The algorithm in use may be driven by a loan transaction objective. This, in turn, may allow a distance analysis used in cluster analysis to be calibrated in the context of specified loan transaction objectives. That is, in the present disclosure, clusters that more closely match the lender's case are created, and thus may correspond to semi-supervised subdivision as opposed to fully unsupervised subdivision.

Regarding social status, reputation, endorsement, and personal data, other characteristics (e.g. friendships, partnerships, attitudes, habits, purchasing trends, travel patterns, long-term goals, participation in extracurricular activities, and stability) that may affect the credit value may be applied to the approach of the credit prediction model described above. Partnerships may include neighbors, classmates, educators, colleagues, and employers. Mindsets may reflect specific endorsements to borrowers held by friends, family, and partnerships, or more general overall views. Purchasing trends may correspond to recurring costs of daily activities. Travel patterns may vary from everyday habitual activities, such as daily commutes for school or work, to long-term trips for personal reasons. Long-term goals may be ambitions for future achievement or obtainment. For example, buying more land to expand a farm may be a long-term goal. Another long-term goal may correspond to completing a higher level education or vocational training program. Extracurricular activities may more broadly reflect hobbies or duties and may be easily affected by lifestyle and life stage factors.

An individual's stability may reflect a term during which the individual has resided in a particular location. If the borrower has lived with their parents all their lives and the parents have lived in the same house for 30 years, this may be more stable than if the parents moved to eight different locations in the last five years. In other words, if the user lives with his/her parents for the rest of life, the user may feel stable, but if the user moves frequently within a short period of time, stability may decrease. Stability or instability may also be reflected in the rate at which the borrower's lifestyle changes. If the borrower frequently changes friends or engage in extracurricular activities, they may have a higher correlation to instability than a borrower who has regular, steady social patterns with friends.

Stored queries may be activated using a function of database management systems and structured query languages. A borrower data file required for borrower analysis may be created for each new loan request. Borrower data may be extracted by executing one or more queries against queries stored in the database.

The prediction model may dynamically calculate additional variables using predetermined transformation, including user-designated transformation of a basic operation. When additional variables are created, the prediction model may be modified to include the additional variables. The prediction model may often correspond to dynamic views of customer records that change each time the database is updated. A definition of a prediction model may provide documentation of each data element that may be used in the model and analysis. For a structure analyzed by the prediction model, the following may be considered.

Extracurricular activities drive buying trends and travel patterns

Attitudes toward borrowers in friends, family and partnerships affect social status

Habits affect long-term goals

Life stage and lifestyle affect travel patterns

Education affects long-term goals

Long-term goals affects buying trends

Social status reflects life stages and lifestyles

Others

After aggregated data from online social network traces for an identified individual is collected as one record per individual, a ratio based on a derived variable may be created. A ‘person with good prospects’ (a payer) may be an individual who has low debt, a positive social status reflected in the online social network trace, and no conflicts or negative events in the online social network trace. A ‘person with a problem’ (a person who does not pay within a predetermined period of time) may be an individual who is the opposite. They may have measurable debt, questionable social status reflected in their online social network trace, and some conflicts or negative events in their online social trace. Credit attributes may be added to each borrower record.

In an embodiment, preliminary data analysis for basic checks and data validity may be performed. The credit prediction model may test and verify all modeling results performed using the personal information provided by the user and data collected and extracted from the online social network traces. Unlike typical static credit models in which the model and data variables are kept constant, the credit model of the present disclosure may be dynamically retrained prior to application to capture the latest available information. A verification operation may be performed as to whether the information provided by the borrower about himself is the most up-to-date information and as to whether correct information is linked to the borrower. For example, as part of a traditional loan approval process, personal data such as education may be verified from an educational institution the borrower attended as indicated by the borrower. Likewise, a phone number may be verified through a phone book. However, using a social graph, the information the borrower provides about him/her may be confirmed with probability. If the borrower indicates that he works for ‘CrePASS’, other people who work for ‘CrePASS’ may be more likely to be on his social graph. If no one is on the social graph working at ‘CrePASS’, the credit rating process may add a mark (flag) to his profile for a more thorough review and investigation instead of giving him a good credit score. In another embodiment, if the borrower has marked himself as a doctor but his posts on his social network traces are nearly illiterate, his profile may be similarly marked as suspicious and subject to further investigation. Also, if the borrower says that he/she geospatially lives in Seoul for the rest of his life but his family, friends and colleagues are not in Seoul and are frequently mentioned in Busan in his social network traces, then his profile may be marked as suspicious as unverifiable personal data.

In another embodiment of the present disclosure, a credit prediction model using data collected from online social traces may identify and rank all future debts for payability during a collecting process in relation to a credit score. The credit score created by the credit prediction model may be used to assess credit worth. For example, it may mean that a creditor with a higher score is more likely to pay off debt than a creditor with a lower score. Thus, differentiated loan processing may be designed and optimized for each cluster of risk scores of the credit prediction model over time based on the credit score.

In another embodiment, the processing method based on the determined processing type may be determined as a function of the credit prediction model.

In an embodiment of the present disclosure, prediction modeling may be performed using more than 1,000 variables collected from the online social traces to include device trace variables such as browser settings, network patterns such as IP addresses or connection types, credit variables and identified attributes. An automated final model equation (scoring equation) that is used to score individuals with outstanding debt may be created to find an individual most likely to pay off the amount owed, through which a settlement behavior may be predicted. In an embodiment of the present disclosure, the expression of scoring may correspond to a statistical regression equation determined by a statistical tool. Since the regression equation generally includes only relevant variables among the more than 1,000 variables that are discovered, only one or two main variables may be used in an embodiment.

As another embodiment of the present disclosure, a process of constructing a plurality of score clusters in a credit prediction model is described. As described above in the corresponding process, a plurality of score clusters or sections may be configured according to desired statistical characteristics by analyzing the data collected from the online social traces. A tree-based algorithm may determine an upper variable dividing the borrower into sections in which proportions of ‘people with good prospects’ and ‘people with problems’ are similar. The corresponding section may be defined as a risk acceptable criterion. For example, a risk acceptable criterion may correspond to a certain level of debt-to-income ratio. An individual with more debt than income may have a debt-to-income ratio of 1.0 or greater. A minimum risk acceptable criterion may correspond to a debt-to-income ratio less than 1.0. In an embodiment, the risk acceptable criterion for the technology described herein may include conditions corresponding to users active in at least one or more social networks. In short, the user may correspond to a user who satisfies a condition that a social trace exists in the social graph.

A method for scoring the user according to the risk acceptable criterion may be provided to an algorithm and used to determine a credit value. The algorithm may include weighting factors that are more or less important to various risk acceptable criterion. The creation and implementation of the algorithm may be generally understood as one of the general technology in the art of the present disclosure.

As described further, the borrower may be assigned to one of the score clusters based on a credit score G determined in the risk acceptable criterion analysis applied to a combination of the data collected from the online social traces and the available personal data.

Each borrower in a sampled population of borrowers may be assigned to one of six score clusters or sections based on a related credit score. For example, a borrower who meets a criterion for age and long-term goal (301≤G<500) may be assigned to score cluster 2, and a borrower who meet a criterion for asset and education level (500≤G<700) may be assigned to score cluster 3. Over a thousand variables may be used based on the data collected from the online social traces, but may be limited to variables that are most important to lenders in scoring to reduce calculations to determine desired repayment goals. In other words, lending agents may weight the score calculation to give various degrees of importance to factors that determine the credit value.

According to the process, an individual may be classified into one of six score clusters according to his/her credit score. Each of the six score clusters or sections may be assigned a separate model equation or score expression. The process may determine the repayment score using a related score expression. If the borrower is assigned to score cluster ‘3’ based on the borrower's G-score, the borrower's repayment score may be determined using the credit prediction model ‘3’ equation. In an embodiment of the present disclosure, the process may determine and initiate a repayment processing type based on the borrower's assigned repayment score. In an embodiment, if two borrowers have the same repayment score but are assigned to different score clusters, the repayment processing type may be the same. (However, embodiments of the present disclosure may give the same repayment score for different score clusters and associate them with different repayment processing types. That is, the repayment processing type depends on the score cluster.)

Repayment score clustering and processing may be continuously changed and improved over time. In the above embodiment, G may be used to score all borrowers. The use of G may provide an additional authority to the credit prediction model.

According to another embodiment of the present disclosure, reputation, identity or trust scores may be calculated using online biometric information such as typing habits, voice content, and body images including photos (sometimes referred to as biometrics). Technology of verifying personal data may support the development of unique human DNA or a biometric database that cross-references identities with the online trace scores for use in identification. This embodiment may be used for identification as well as help reduce medical paperwork and prevent fraud.

In addition, the function of a process to assess a user's personality may support the development of reputation scores that may be used for non-financial transactions such as equipment rental, information sharing, leasing, bartering, and swaps.

According to another embodiment, aspects of the user computing device 120, such as time settings used to access a service, browser type, browsing history, browser settings (sometimes referred to as a machine fingerprint) may be used to determine scoring related to identity or trustworthiness.

According to another embodiment, a reputation or trustworthiness score may be calculated using aspects of a network configuration such as connection type, proxy usage, IP address, geographic location, WIFI ID, DNS server, or connection speed (sometimes referred to as network fingerprint).

In another embodiment of the present disclosure, fees may be charged in a variety of ways, including applying for loans, assessing credit scores, monitoring endorsements and online reputations, and helping others in a community by supporting trusted and reputable individuals. Applying fees along with the relevant functions of the present disclosure may reduce fraud and prove that every borrower has a bank account so that each borrower is a real person and may repay mechanically.

A further embodiment of the present disclosure may operate on the premise of the use of location record parameters retrieved from a loan applicant's mobile device, such as a smartphone to predict a baseline risk that is lower than a baseline risk related to traditional personal data of the loan applicant. As a result, a higher loan approval rate may be achieved without increasing the risk of default.

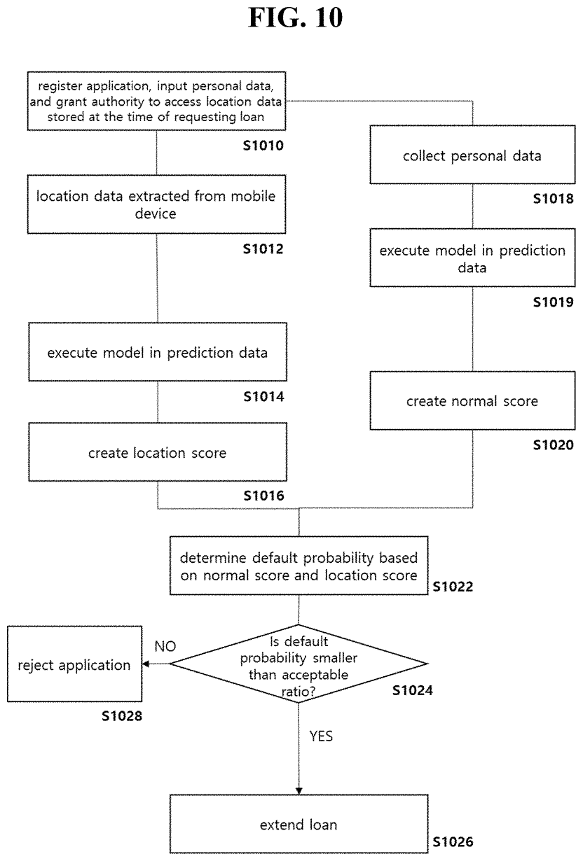

FIG. 10 is a flowchart illustrating an embodiment of a loan transaction according to the present disclosure.

Referring to FIG. 10, a loan applicant may input personal data into a loan application app of a mobile device as indicated in operation S1010 and may grant an authority to access location record data stored in the mobile device.

The stored location record data may be retrieved as indicated in operation S1012. In operation S1014, the most predictable location record data with a lower default rate may be processed to create a location credit score (hereinafter referred to as a ‘location score’) as indicated in operation S1016.

For example, the loan applicant's traditional personal data including name, age, number of dependents, residency status, net salary and employment status may be extracted by or on behalf of a lender as indicated in operation S1018 and indicated in operation S1019. Also, as indicated in operation S1020, a traditional credit score (hereinafter referred to as a ‘normal score’) may be created.

Both a normal score and a location score may be received in operation S1022 and a default probability may be created. Thereafter, in operation S1024, it may be determined whether the default probability of the loan applicant is less than or equal to an unacceptable ratio of the lending institution.

If the default probability of the loan applicant is less than or equal to the allowable default probability, the loan may be extended as indicated in operation S1026. If the default probability is higher than the allowable rate, the application may be rejected as indicated in operation S1028.

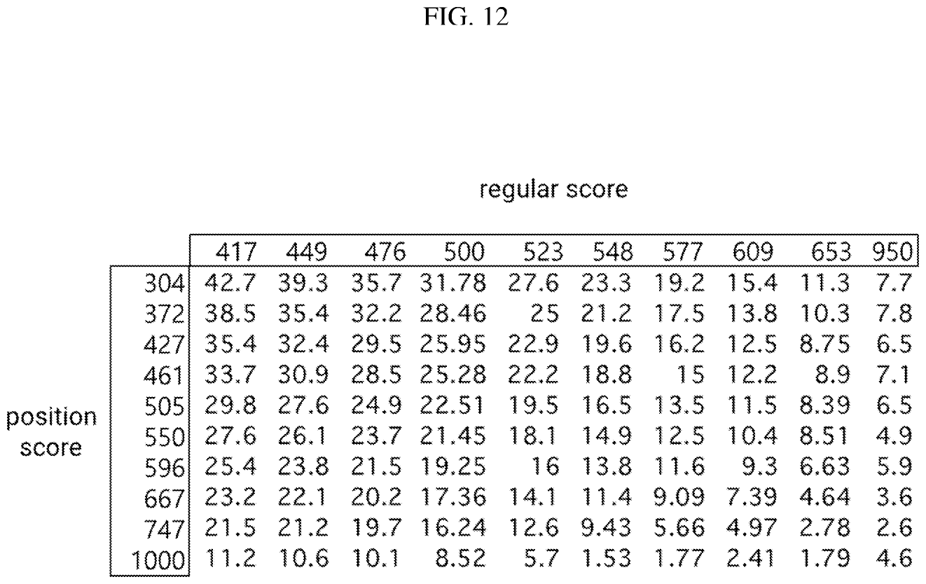

FIG. 12 is a view illustrating a process of calculating a default rate according to the present disclosure.

Referring to FIG. 12, each applicant may be allocated to 10 categories (e.g., 0 to 417, 418 to 449, 450 to 476, 477 to 500, 501 to 523, 524 to 548, 549 to 577, and 578 to 950) based on the applicant's existing personal data. A loan was extended to each applicant and a default rate related to a normal score of each category may be calculated and displayed in a row directly corresponding to a relevant normal score range.

An application may additionally include an authority to access and extract location data records stored on the loan applicant's mobile phone. History of accessed location data may include GPS data from last year and location data extracted from photos stored in the applicant's mobile phone last year. The location-based data extracted from the stored photos may include image collection locations, i.e., latitude and longitude, and image collection date and time.

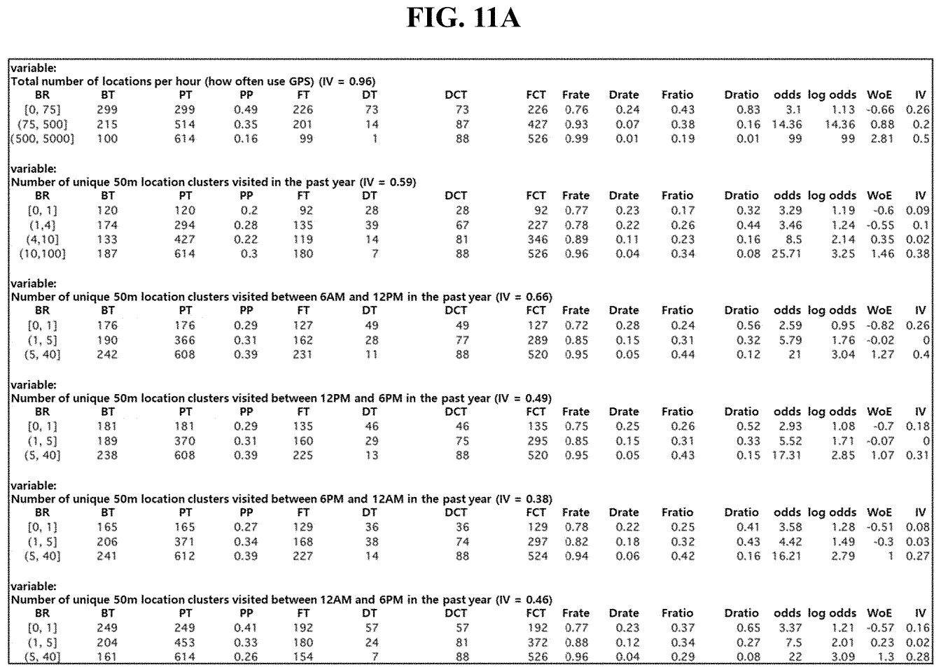

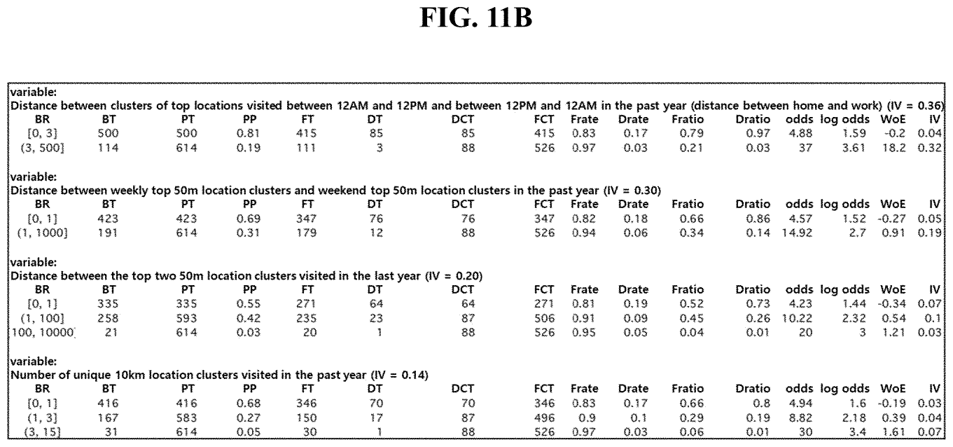

Although over 80 location-based variables may be extracted, only certain variables may be utilized as the best predictor of a lower risk of default. The spreadsheets of FIGS. 11A and 11B may indicate the most important location variables and their respective prediction information values IV. Variables with an IV of 0.1 or greater may correspond to variables suitable for use in a credit prediction model.

For example, the following variables may be considered to be the best predictors of a low default risk and may be modeled to determine each loan applicant's location score in order of least importance.

Number of location records per hour (cumulative time with GPS turned on)

Number of unique 50 m location clusters visited

Number of unique 50 m location clusters visited between 6 am and 12 pm

Number of unique 50 m location clusters visited between 12 pm and 6 pm

Number of unique 50 m location clusters visited between 6 pm and 12 am

Number of unique 50 m location clusters visited between 12 am and 6 am

Distance between clusters of upper locations visited between 12:00 am and 12:00 pm and between 12:00 pm and 12:00 am

Distance between the weekly upper 50 m location cluster and second most frequent 50 m location cluster

Distance between upper two 50 m location clusters

Number of unique 10 km location clusters visited

Referring to FIG. 12, each loan applicant may be allocated location scores belonging to 10 categories (e.g., 0 to 304, 305 to 372, 373 to 427, 428 to 461, 462 to 505, 506 to 550, 551 to 569, 597 to 667, 667 to 747, and 748 to 1000), which may be determined based on the applicant's predicted location data.

The default rate may be calculated for all loan applicants within each normal score range (corresponding to the rows in FIG. 12) and each location score range (corresponding to the columns in FIG. 12). For both the location score and the general score, an increase in the scores may be understood to mean that a baseline risk decreases.

A cumulative default rate may be prepared in a table and may be as shown in FIG. 12. The top row of FIG. 12 may represent a default rate related to each normal score range related to the lowest location score range, and may be considered the same as the existing score without using the location score.

A default rate of an applicant having a normal score in the ‘577’ category and a location score in the ‘372’ category is reduced to 17.51% that is acceptable, and a default rate of an applicant having a normal score in the ‘577’ category and an increased location score in the ‘1000’ category is dropped to 1.77%, which may significantly reduce their risk of default.

Similarly, an acceptable risk value below the lender's 18% threshold may be obtained when considering the location score. For example, if the normal score is 417 and the location score is 1000, the default rate may be 11.16%. Through this, it can be seen that a total of 25 combinations of the normal score range below ‘577’ and the location score range below ‘1000’ achieved an acceptable default rate below the 18% threshold. As a result, loan applicants with these scores may be approved without increasing the risk of default.

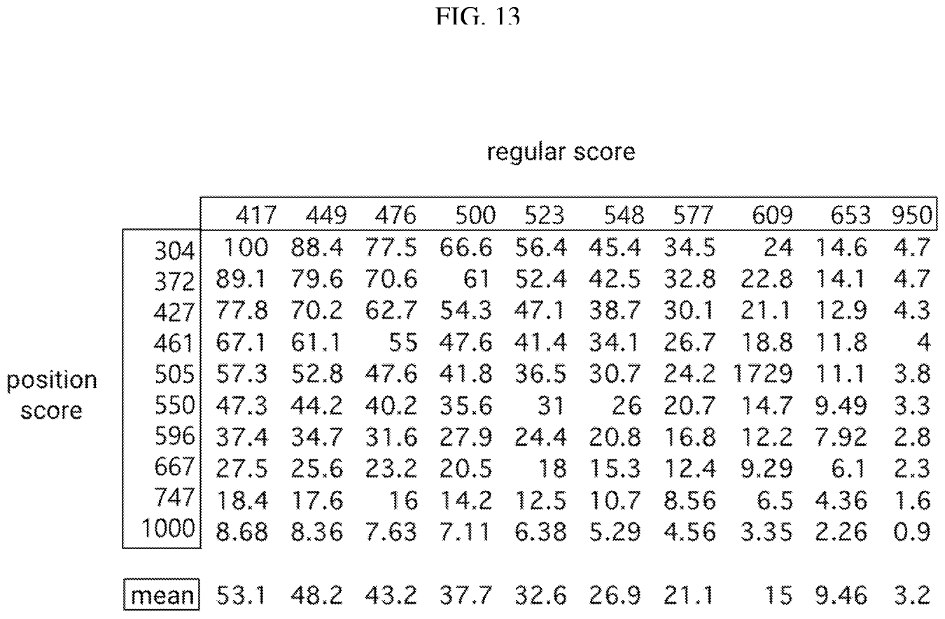

FIG. 13 is a view illustrating a cumulative approval rate according to the present disclosure.

Referring to FIG. 13, using the lowest score cutoff, that is, the normal score 417 and the location score 304 for loan extension, the highest approval rate may be obtained as indicated in the upper left corner. As the score cutoff range increases, the approval rate may decrease.

By utilizing the normal score cutoff of ‘577’ and the location score cutoff of ‘372’, an acceptable default rate of 17.51% may be obtained as shown in FIG. 12. Also, when the approval rate is 32.75% while the location data score and normal score cutoff is ‘577’, the default rate may be 19.2% and the approval rate may be 21.13%. By using location scores, a loan approval rate may be increased by about 50% without increasing the risk of default.

The present disclosure may include performing certain selected tasks or steps or a combination thereof automatically or manually. A number of selected steps may be performed by a data processor, such as a computing platform, for executing a plurality of instructions. Selected steps of the method and system of the present disclosure may be implemented by hardware or software on any operating system in any firmware or a combination thereof. For example, selected steps of the present disclosure as hardware may be implemented as a chip or circuit. Selected steps of the present disclosure may be implemented as a plurality of software instructions executed by a computer using any suitable operating system.

Unless defined otherwise, all technical and scientific terms used in this document may be interpreted to have the same meaning as commonly understood by those skilled in the art. The materials, methods, and examples provided herein are not intended to be limiting and may be presented for illustrative purposes only. Any coverage or device values provided in this document may be extended or changed without losing an intended effect, which will be apparent to those skilled in the art for understanding the teachings herein. Moreover, computer software and/or data representations may be clearly used in the design and production of hardware devices or other devices embodying the present disclosure, and it may be understood that such programs also fall within the scope of representation of the described methods of the present disclosure.

As will be apparent to those skilled in the art, hardware devices may include computer systems including at least one computer such as a microprocessor, a microprocessor cluster, a main frame, and a network workstation. A model of the present disclosure may be implemented as a computer-readable medium having computer-executable instructions and distributed to borrowers through secure communication channels or as a device utilizing a computer system. Computer systems may include wireless handheld devices, multiprocessor systems, microprocessor-based or programmable consumer electronics, networked PCS, minicomputers, notebook computers, tablet computers, main frame computers, personal social assistants, smartphones and computers, etc.

A computer system may be integrated into a device that analyzes input data and consequently initiates a loan transaction. The computer may include a central processor, system memory, and a system bus that connects various system components, including the system memory, to the central processor device. The system bus may correspond to one of several types of bus structures, including a memory bus or memory controller, a peripheral bus, and a local bus using various bus architectures. A structure of the system memory is well known to those skilled in the art and may include one or more program elements such as a basic input/output system (BIOS) and operating system stored in read only memory (ROM), software application programs, and program data stored in random access memory (RAM).

In addition, the present disclosure may also be run in distributed computing environments where tasks are performed by remote processing devices that are linked through a communications network. In a distributed computing environment, program components may be located in both local and remote memory storage devices. A computer may operate in a networked environment using logical connections to one or more remote computers, servers, routers, network personal computers, peer devices or other devices such as other common network nodes, wireless telephones or wireless personal social assistants.

For further details related to the present disclosure, materials and manufacturing technology may be used within the level of those skilled in the art. This may be equally applied to the method-based aspect of the present disclosure in terms of additional operations that are generally or logically used. In addition, any selective features of the modifications of the present disclosure described above may be presented and claimed independently or in combination with any one or more features described above. Similarly, references to singular items may include the possibility of presence of several same items. More specifically, the singular forms used in this document and the claims may include plural referents unless expressly indicated otherwise. Claims may be prepared to exclude any selective element. Accordingly, this document is intended to be used as antecedent to the use of exclusive terms such as ‘exclusive’, ‘only’, etc. in connection with the citation of a claim element or use of a ‘negative’ limitation. Unless defined otherwise in this document, all technical and scientific terms used in this document may have the same meaning as those commonly understood by one of a person skilled in the art to which this invention pertains. The scope of the present disclosure is not limited by this document, but only by the clear meaning of the terms of the claims in use.

### DETAILED DESCRIPTION OF MAIN ELEMENTS

100: computer network system

110: network

120: computing device

128: data service device

134: other user computing device

150: data storage

400, 500, 600,700: Web page

402: social network

1. A method for creating an alternative data risk assessment using mobile data, the method comprising:
collecting mobile risk data from a mobile terminal;
constructing a mobile data risk model for a risk assessment by analyzing the mobile risk data;
assessing a risk of a specific user using the mobile risk data and the mobile data risk model; and
executing a loan for the specific user according to a result of the assessment,
wherein the collecting of the mobile risk data includes
receiving log-in information for the specific user's online social network input by the specific user through an internet browser,
checking the log-in information to verify the specific user's identity,
after the verification of the specific user's identity, forming a social graph and collecting posts on specific user's online social trace based on the specific user's social relationship or contact information retrieved from the specific user's online social network, and
collecting, as the mobile risk data form the mobile terminal, data collected from the social graph and the posts collected from the online social trace.

2. The method of claim 1, wherein the collecting of the mobile risk data includes:
receiving risk data at a specific time from the mobile terminal; and
obtaining an authority to access data for the mobile terminal in a process of transmitting the risk data.

3. (canceled)

4. The method of claim 1, wherein the assessing of the risk includes:
determining a risk variable from the mobile risk data; and
creating the mobile data risk model using the risk variable as a model variable.

5. The method of claim 1, wherein the executing of the loan includes determining at least one of a loan interest rate and a loan period for executing the loan according to the result of the assessment.

6. The method of claim 1, further comprising:
adding the specific user to a group of loan holders when the execution of the loan is completed; and
performing a periodic risk assessment on the group of loan holders to determine a loan management procedure for the corresponding loan holders.

7. The method of claim 6, wherein the determining of the loan management procedure includes changing a notification schedule of the corresponding loan holder or changing a collection procedure in case of overdue according to the result of the risk assessment.

8. An apparatus for creating an alternative data risk assessment using a mobile data, the apparatus comprising:
a data collecting unit configured to collect mobile risk data from a mobile terminal;
a risk model constructing unit configured to construct a mobile data risk model for a risk assessment by analyzing the mobile risk data;
a risk assessing unit configured to access a risk of a specific user using the mobile risk data and the mobile data risk model; and
a loan executing unit configured to execute a loan for the specific user according to a result of the assessment,
wherein the data collecting unit is further configured to
receive log-in information for the specific user's online social network input by the specific user through an internet browser,
check the log-in information to verify the specific user's identity,
after the verification of the specific user's identity, form a social graph and collect posts on specific user's online social trace based on the specific user's social relationship or contact information retrieved from the specific user's online social network, and
collect, as the mobile risk data form the mobile terminal, data collected from the social graph and the posts collected from the online social trace, and
wherein the data collecting unit, the risk model constructing unit, the risk assessing unit, and the loan executing unit are each implemented via at least one processor.
